(19) United States
(12) Patent Application Publication
(10) Pub. No.: US 2008/0182061 A1
(43) Pub. Date: Jul. 31, 2008

(54) AWARD TROPHIES WITH ENHANCED RECIPIENT ASSEMBLY CHARACTERISTICS

(76) Inventor: Scott E. Siegel, Evanston, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/627,103

(22) Filed: Jan. 25, 2007

(51) Int. Cl. B32B 3/02; B23P 11/00

(52) U.S. Cl. 428/66.5; 29/428

(57) ABSTRACT

An award trophy assembly and method are provided that include an annular base and a flexible strip or placard which may be engraved after an award is received by a recipient and added to the base in a seamless member. Connector members are provided to secure the flexible strip around the annular base.

### FIELD OF THE INVENTION

The present invention generally relates to award trophies and methods of making award trophies. More particularly, this application relates to award trophies which may be assembled by the recipient after an awards ceremony, and especially to enhancements therein while providing a seamless-appearing easily added placard onto which the name of the recipient and other desired information is engraved or otherwise placed after an awards ceremony.

### BACKGROUND OF THE INVENTION

Award trophies are prevalent in various businesses, organizations and industries. Such award trophies are commonly adorned with statuettes or other designs. In most instances, the awards include engraved name plates identifying the recipient, the award received and other pertinent information as desired. Known award trophies include cylindrical bases that have name plates along the annular shape of the award trophy cylindrical base.

By an approach that has been in use for years in the entertainment industry, for example, an award trophy is given at an awards ceremony with a “blank” or incomplete base assembly. This base assembly includes a blank rigid cylindrical intermediate component sandwiched between the top component and the bottom component of this type of base assembly. Later, a replacement rigid cylindrical intermediate component is shipped to the recipient of the award. This replacement rigid cylindrical intermediate component is engraved with the pertinent information for the specific award, such as the name of the recipient, the identity of the award or awards organization, a date, award specifics and/or inspirational wording. This replacement component is substituted for the “blank” cylinder, requiring disassembly of the award trophy, either completely or at least of its base, to remove the blank cylinder and insert the rigid replacement cylinder, followed by reassembly with the replacement rigid cylinder in its proper place within the base assembly.

These types of award trophies are used for award ceremonies that are comprised of proceedings wherein the recipient of the award trophy is unknown until it is unveiled at the award ceremony. In such cases, because the recipient of an award trophy is unknown prior to presentation of the trophy, engraving of the award trophy cannot be accomplished prior to presentation, typically to avoid the possibility of premature disclosure of the identity of the recipient. Under such circumstances, one possible approach would have a new, engraved award trophy issued and exchanged at a later date for the unengraved trophy received at the award ceremony. This increases cost and can lessen the recipient's satisfaction in owning the actual award trophy given at the awards ceremony.

Alternatively, as noted above it is known for a portion of the trophy, such as an engraved rigid base cylinder, to be subsequently exchanged with the recipient for the unengraved rigid base cylindrical component from the award trophy that had been presented at the awards ceremony. With this approach, the awards manufacturing company has been known to engrave the fresh or replacement cylindrical component with the pertinent information and send it to the award recipient. Then it is up to the award recipient to later dismantle the award he or she had been handed during the ceremony in order to remove the unengraved cylindrical component from the award trophy that had been presented. Thereafter the recipient must insert the engraved rigid cylindrical component into its proper location within the base and reassemble the award trophy, while returning or properly disposing of the blank or unengraved rigid cylindrical component of the base.

Thus, there is a need in the industry for an approach that avoids having to disassemble the base in order to substitute an engraved or otherwise completed rigid and/or bulky cylinder for a blank cylinder on an award given at an awards ceremony. Such a need is especially problematic for awards having a cylindrical name plate base component that is secured to the base and to the statuette or the like as a structural component of the base assembly and/or of the entire award.

Certain other types of trophies have simple bases with a cylindrical portion and have a relatively short name plate that fits on a portion of the cylinder, leaving a large section of the cylinder unaffected by and uncovered by the name plate. These trophies fall far short of providing an aesthetically pleasing award having a cylindrical base with a full and substantial annular section that also serves to personalize the award for the particular recipient.

It is accordingly a general aspect or object of the present invention to provide aesthetically pleasing award trophies having a cylindrical base and which may be issued in conjunction with an awards ceremony where an award trophy recipient is unknown prior to issuance and without the necessity of either later disassembling the award given to the recipient or later providing an entirely new trophy or trophy base.

Another general aspect or object is to provide an award trophy, issued in circumstances where the recipient information is added to the award trophy after its receipt and where the trophy recipient is not unduly burdened by having to later add such information to his or her award.

It is an aspect or object of the current invention to provide a cost-effective and aesthetically pleasing award trophy which is especially suitable for ceremonies wherein the recipient is unknown prior to issuance.

### SUMMARY OF THE INVENTION

In one embodiment or aspect of the present invention, the award trophy comprises a first member being a cylindrical base component having a vertical cylindrical side wall. A second member is an elongated wrap-around placard that is easily bendable or is pre-curved or partially pre-curved and has a length equivalent to the external circumference of the side wall and a width equivalent to the height of the side wall of the cylindrical base component such that when the placard is wrapped around the side wall it completely covers the side wall, and the seam between the ends of the placard virtually disappears. Both the first member and the second member have connector holes which are closely spaced on the first member and close to the ends of said second member such that when the placard is wrapped around the vertical side wall it is possible to perfectly align the holes of the two members to provide the desired seamless-appearing condition. The trophy base has a top onto which a statuette or other award design typically is mounted.

In a second embodiment, a first member being a cylindrical base assembly is equipped with a vertical cylindrical side wall and a base top that adorns the top of said award base wall. Such base top contains an indentation at or near the annular edge that is sized to hold the cylindrical side wall. A second member is an elongated wrap around placard that has a length equivalent to the external circumference of the side wall, the width of such placard being large enough to cover the external sidewall which in turn covers the protruding part of the base top. Connector members and precisely placed holes in the first and second members are provided, such that the second member may easily be secured around the first member when the award trophy is otherwise fully assembled.

In a further embodiment, an elongated placard or engraved plate is manually wrappable completely around a cylindrical base of an award trophy, and connection members are used to easily and securely attach the elongated placard around the cylindrical base of the award trophy, while the cylindrical base has a side wall that initially is blank, and both the blank side wall and the secured engraved placard give a substantially identical aesthetically pleasing appearance.

### BRIEF DESCRIPTION OF THE DRAWINGS

FIG. 1 is a front elevational view, partially in cross-section, of an embodiment of an award trophy according to the present invention;

FIG. 2 is a transverse cross-sectional view along the line 2-2 of FIG. 1;

FIG. 3 is an elevational view of a placard or wrap-around engraving plate according to an embodiment of the present invention;

FIG. 4 is an end view of the placard of FIG. 3;

FIG. 5 is an elevational view of an award trophy with the placard wrapped around and assembled thereto according to an embodiment of the invention; and

FIG. 6 is an enlarged partial cross-sectional view of an embodiment of the base.

### DETAILED DESCRIPTION OF PREFERRED EMBODIMENTS

As required, detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

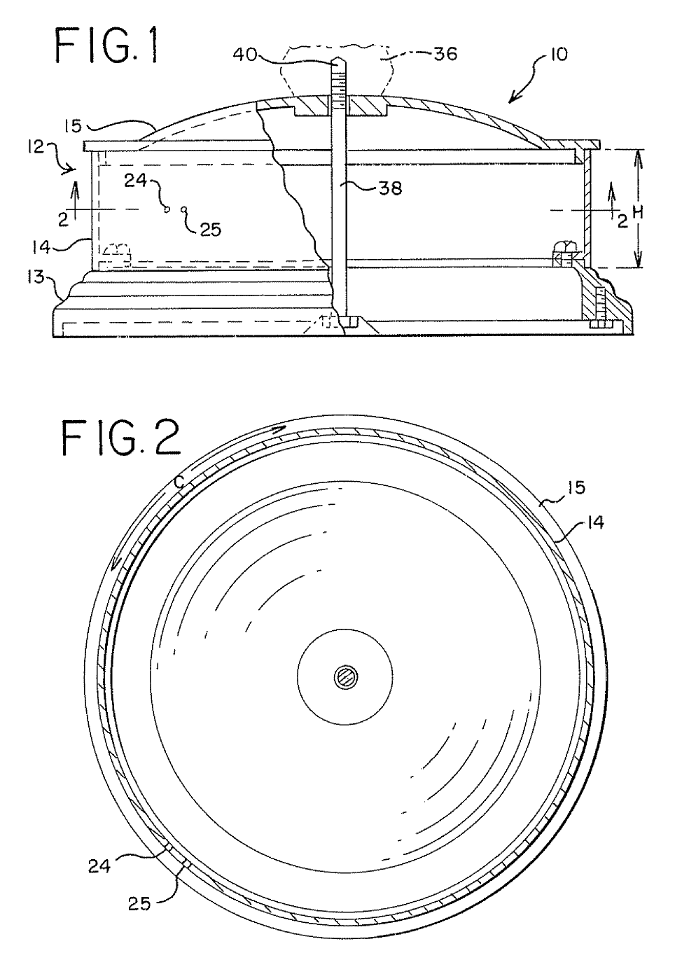

Referring to FIG. 1, an award trophy is generally illustrated by reference number 10. The award trophy 10 is comprised of a first member being a cylindrical base generally designated at 12. The base 12 typically also includes an upper surface for supporting the award as generally discussed herein. Often the cylindrical base is an assembly of a bottom 13, a side wall 14 and an upper member 15. However, with the arrangement disclosed herein, the cylindrical base may be constructed by an assembly of more or fewer than three components and can be a unitary member.

Often, the manufacturing specifics will depend on the needs of the award, which can be primarily aesthetic needs, such as when the dome must be plated or otherwise finished to give properties and an appearance different from other locations of the cylindrical base. For example, in some embodiments, it is aesthetically desired to have the bottom 13 and upper member 15 have the same or complementary appearance or finish properties (for example gold plated), while the side wall 14 has contrasting appearance or finish properties (for example black).

Irrespective of how the base is assembled, the annular side wall 14 of the cylindrical base or first member 12 is vertically oriented when in use and has a circumference “C” (shown in FIG. 2). The side wall 14 also has a height “H” that is sized and shaped to accommodate a second member, engraving plate or placard 16 as discussed in more detail herein.

This second member 16 is an elongated wrap-around placard or engraving plate which can be characterized as a flexible strip. This placard 16 has a length “L” that is bounded by end edges 17, 18. This length “L” is virtually identical to the circumference “C” of the exterior of the annular side wall 14. Thus, when the second member or placard or engraving plate 16 is wrapped around the side wall 14, the opposing end edges 17 and 18 of the elongated placard 16 do not overlap with each other, it being understood that overlapping would create an uneven surface.

Furthermore, it is an objective that there is no gap or virtually no gap between the opposing end edges 17 and 18 after the placard 16 is wrapped around and secured to the side wall 14 of the cylindrical base. This “no gap” or “seamless” feature is illustrated in FIG. 5 at 19, with this spacing between end edges 17 and 18 being exaggerated in FIG. 5 for drawing clarity. It will be appreciated that the seamless feature 19 has the end edges 17, 18 abutting and flush with each other.

It is most advantageous to have the opposing end edges 17 and 18 of the placard 16 meet flush together. This results in a mounted circular placard that is seamless, or at least gives an appearance and/or perception of seamlessness to the unaided eye so as to have the assembled placard appear the same as the annular side wall 14 of the cylindrical base 12 prior to adding the placard, when this is considered to be a desired objective. Such an objective would be desired, for example, when the award that is handed out at an award ceremony has to have a professional and aesthetically advantageous appearance and when it is important to have the award present that same first-class appearance after the placard is assembled onto the base, typically with the name of the recipient of the award that had been unknown to the public and/or to the recipient prior to the award ceremony.

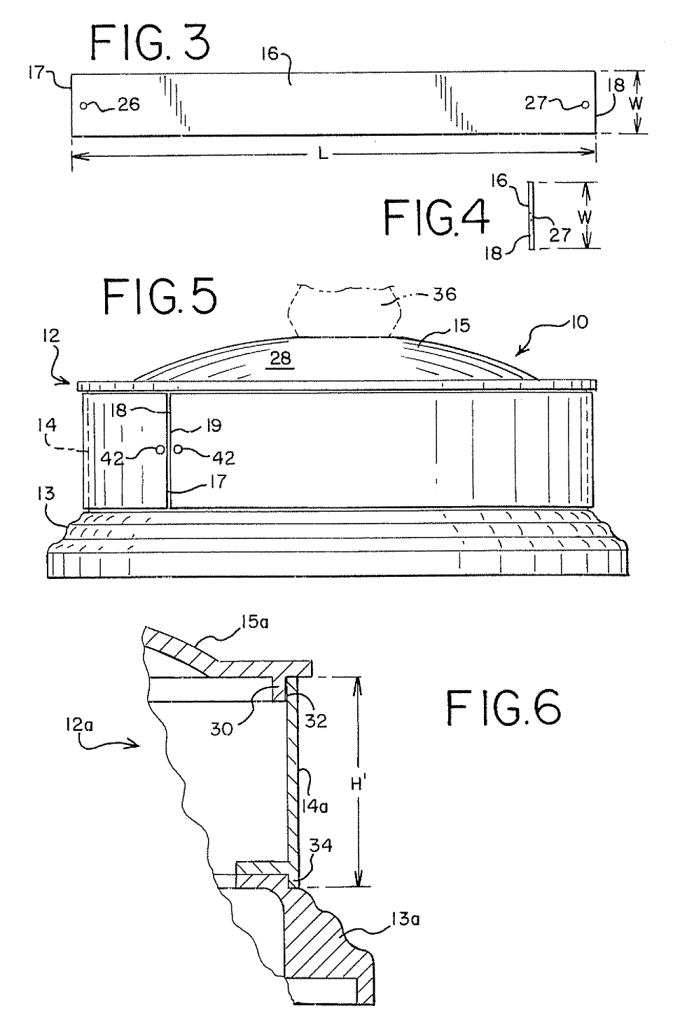

In addition, in the illustrated embodiment, the second member, placard or engraving plate 16 also has a width “W” (shown in FIGS. 3 and 4) that is the same as, or approximately identical to the height “H” of the award in this location, in this embodiment this is the height of the interior side wall of the rigid cylindrical component of the base assembly. With this sizing approach, the objective stated herein to have the award base have the same appearance both before and after the placard is curved over and assembled to the base is further facilitated. For example, the surface of side wall 14 can be covered by the placard 16 throughout the approximate entire height of the side wall, as generally shown in FIG. 5.

Also the thickness of the placard 16, illustrated in FIG. 4, is relatively thin. Typically the placard is steel or other durable metal not more than about 2 mm in thickness, typically less than about 1.5 mm and can be on the order of 1.0 mm in thickness or less. The material and gauge or thickness of the placard 16 should be such that the placard readily curves around the side wall without kinking, creasing, breaking, tearing or being damaged in any way. Typically this can be accomplished even if the placard is delivered to the award recipient in a fully flat condition.

In some instances, good assembly of the placard 16 onto the side wall 14 can be facilitated by imparting a gradual curve to the placard before it needs to be assembled onto the side wall. Usually, it is not desirable to have any such curve (if provided at all) be so completely toward a cylindrical shape that the curve would seriously interfere with the ability of the placard 16 to clear the cylindrical wall during the assembly process. For example, the aforesaid gradual curve that can be imparted to the placard will be enough to provide an initial curvature that will assist full cylindrical wrapping without creasing but will be short of semi-cylindrical in shape.

Generally, the side wall 14 is equipped with at least two opposing closely spaced holes 24, 25. At least two of the opposing holes 24, 25 are spaced substantially close together to hold the ends of the placard or second member 16 in place. The spacing between the opposing holes 24, 25 is selected such that the ends of the wrapped around curved placard or engraving plate 16 coincide with the curved surface of the cylindrical base. Also the connector holes in the engraving plate or placard coincide with the opposing holes 24, 25. These details help to preclude bow-out and/or gapping between the cylinder of the base and the placard, or between the opposing end edges 17, 18 of the placard. Overlap of one placard end over the other placard end also is thereby precluded. Typically, such spacing between the opposing holes 24 and 25 of the side wall 14 is, by center-to-center measurement, not greater than about one inch (25.4 mm), often not greater than about 0.75 inch (about 19 mm), not greater than about 0.5 inch (12.7 mm), and can be as close as not more than about ⅜ inch (about 9.5 mm).

The placard, engraving plate or second member 16 generally is equipped with at least two connector holes 26, 27 being complementary in size to the closely spaced holes 24, 25. At least two of the connector holes 26, 27 are spaced substantially close to the respective end edges 17, 18 of the placard or second member 16 such that when the placard or second member 16 is wrapped around the side wall 14, the connector holes 26, 27 directly overlie the corresponding closely spaced holes 24, 25 of the side wall 14.

In one embodiment, the upper portion of the base may take the form of a base dome 28 (shown in FIG. 5) to adorn the top of the cylindrical base or first member 12. This base dome 28 is provided in order to hold a statuette, award, figure, decorative panel or any other design or component that can provide a primary focus of the award or trophy.

In one embodiment, perhaps best seen in FIG. 6, the cylindrical base 12a has a side wall 14a that is defined by a unitary member so as to present a clean uniform surface and appearance prior to addition of the placard or engraving plate. This uniform surface is designated at “H′” in FIG. 6. With this approach, there is no intrusion by other components into this uniform surface.

With further reference to the uniform surface of side wall 14a through height “H′”, the upper member 15a has an annular indented lip or base 30 in the form of an annular protrusion that forms an indent 32 to receive the side wall 14a. Further, the bottom portion 13a has an indent 34 to receive the bottom portion of the side wall 14. The indents 32 and 34 lie along the same cylindrical plane, and only the uniform surface of side wall 14a is noticeable prior to addition of the placard 16. Also, the placard or engraving plate 16 can then be wrapped around the first member 12 and completely cover the side wall 14 that covers the base 30.

A plurality of connecting members 42 (seen in FIG. 5) is provided. Each connecting member is sized to fit into the connector holes 26, 27 of the placard 16 when wrapped around the side wall and then into the closely spaced holes 24, 25 of the cylindrical side wall 14. The fit between the connecting members and the respective holes is for assembling the engraving plate or placard onto the award base. Connecting members 42 can be screws, bolts, brackets, brads or the like or any other connecting member known in the art. Typically, screws are preferred, in which case at least the closely spaced holes 24, 25 will be threaded to facilitate secure assembly of the placard 16 onto the cylindrical side wall 14. Usually, the connecting members will be interchangeable so the user is not required to make a selection between or among the connecting member needed for a particular connector hole and/or closely spaced hole, for example.

In another embodiment, either or both of the cylindrical side wall 14 and the placard, engraving plate or second member 16 may be equipped with an adhesive in order to secure, or typically assist in securing, the second member, engraving plate or placard 16 around the cylindrical side wall 14 of the base 12.

It will be appreciated that an award statuette, design or the like, shown in phantom at 36 typically rests on top of the base to provide the completed award trophy. The version shown in FIG. 1 is typical of the award trophy as it is to be presented to the recipient, whose identity is highly confidential and secret until the moment of presentation. The statuette or the like 36 is suitably secured to the base such as by assembly an elongated bolt 38, often facilitated by a threaded cavity 40 in the statuette or the like. With the present invention, it is unnecessary to disassemble the statuette from the base and/or to disassemble the base to substitute a side wall member that has been engraved for the typically blank side wall member 14 of FIG. 1. Instead, all components of the award remain intact as the award had been presented to the award recipient, who only needs to later wrap the thin placard or engraving plate around and over the surface of the side wall 14, as shown in FIG. 5.

It will be understood that the embodiments of the present invention which have been described are illustrative of some of the applications of the principles of the present invention. Numerous modifications may be made by those skilled in the art without departing from the true spirit and scope of the invention, including those combinations of features that are individually disclosed or claimed herein.

1. An award trophy comprising:
a first member being a base having a cylindrical and annular side wall capable of supporting a trophy member, said side wall having an external cylindrical circumference, and said side wall has at least two opposing closely spaced holes along said external cylindrical circumference of the side wall of the base;
a second member being a placard that is an elongated and flexible strip having a length approximately identical to the external circumference of said side wall of the base, said length being defined between two end edges of the placard, said placard includes at least two connector holes;
at least two connecting members, each connector hole of the side wall being adapted to receive one of said connecting members for assembly of the placard onto the side wall of the base;
said at least two connector holes are spaced a given distance from said end edges of the placard such that when said placard is wrapped around said cylindrical side wall, each of the connector holes of the placard aligns with said closely spaced holes of the side wall and said two end edges of the placard are not readily visible to the unaided eye after assembly of the placard onto the side wall by the connecting members; and
an award positioned on said first member base at a location on the base other than on said cylindrical side wall.

2. The award trophy of claim 1, wherein said placard, after assembly onto said side wall with the connecting members, has an appearance substantially the same as that of the side wall of the base prior to assembly of the placard thereonto.

3. The award trophy of claim 1, wherein said placard is an engraving plate onto which indicia pertinent to the award are positioned.

4. The award trophy of claim 1, wherein the placard assembled onto the side wall by the connecting members is devoid of a visible gap between said end edges of the placard positioned onto the side wall of the base, said side wall being vertical when the award trophy is displayed upright.

5. The award trophy of claim 4, wherein said end edges of the placard abut one another and are sized and shaped to be complementary with each other so as to meet flush with each other.

6. The award trophy of claim 1, wherein said side wall has a selected height, and said placard has a width that is approximately identical to said selected height of the side wall.

7. The award trophy of claim 1, wherein said placard is comprised of a metal material and has a gauge or thickness of not more than about 2 mm.

8. The award trophy of claim 1, wherein said placard is substantially flat prior to assembly onto said side wall and is cylindrical after assembly onto said side wall.

9. The award trophy of claim 1, wherein said placard exhibits a gradual curved condition along its length.

10. The award trophy of claim 1, wherein said at least two opposing closely spaced holes of the base side wall exhibit a center-to-center spacing therebetween of not greater than about one inch (25.4 mm).

11. The award trophy of claim 1, wherein said first member is an assembly of components including a top part, a bottom part and an intermediate part containing said side wall of the base, further including an elongated bolt connecting together all of said award, said top part, said bottom part and said intermediate part.

12. The award trophy of claim 11, wherein said intermediate part has said external cylindrical circumference of the base that is approximately identical to the length of the placard, said intermediate part has a selected internal circumference, said top part of the base has an downwardly extending annular protrusion having a circumference substantially equal to said selected internal circumference of the intermediate part, and said intermediate part overlies substantially all of said downwardly extending annular protrusion of the top part.

13. The award trophy of claim 12, wherein said bottom part of the base has an annular indent that has a circumference substantially identical to said selected internal circumference of the intermediate part, and said annular indent of the bottom part receives a portion of said intermediate part.

14. The award trophy of claim 1, wherein said connector members are screws, and said connector holes of the side wall are threaded to receive said screws.

15. An award for recipient final assembly, comprising:
a base having a cylindrical and annular side wall capable of supporting an award such as a statuette, said side wall having an external cylindrical circumference, and said side wall has at least two opposing closely spaced holes along said external cylindrical circumference of the side wall of the base, said closely spaced holes exhibit a center-to-center spacing therebetween of not greater than about one inch (25.4 mm);
a placard engraving plate that is an elongated and flexible strip having a length approximately identical to the external circumference of said side wall of the base, said length being defined between two end edges of the placard, said placard includes at least two connector holes;
at least two connecting members, each connector hole of the side wall being adapted to receive one of said connecting members for assembly of the placard strip onto the side wall of the base;
said at least two connector holes are spaced a given distance from said end edges of the placard strip such that when said placard strip is wrapped around said cylindrical side wall, each of the connector holes of the placard strip aligns with said closely spaced holes of the side wall and said two end edges of the placard strip are substantially devoid of a visible gap therebetween after assembly of the placard strip onto the side wall by the connecting members;
said side wall has a selected height, and said placard strip has a width that is approximately identical to said selected height of the side wall; and
an award positioned on said first member base at a location on the base other than on said cylindrical side wall.

16. The award of claim 15, wherein said placard strip, after assembly onto said side wall with the connecting members, has an appearance substantially the same as that of the side wall of the base prior to assembly of the placard thereonto.

17. The award trophy of claim 16, wherein said placard is an engraving plate onto which indicia pertinent to the award are positioned.

18. The award trophy of claim 1, wherein said first member is an assembly of components including a top part, a bottom part and an intermediate part containing said side wall of the base, further including an elongated bolt connecting together all of said award, said top part, said bottom part and said intermediate part; wherein said intermediate part has said external cylindrical circumference of the base that is approximately identical to the length of the placard strip, said intermediate part has a selected internal circumference, said top part of the base has an downwardly extending annular protrusion having a circumference substantially equal to said selected internal circumference of the intermediate part, and said intermediate part overlies substantially all of said downwardly extending annular protrusion of the top part.

19. A method for recipient addition of award indicia onto an award trophy comprising:
providing an award trophy having a base with a cylindrical side wall having an external circumference and an award such as a statuette mounted on the base;
forming at least two opposing closely spaced holes within the side wall of the base to create an incomplete award trophy assembly having the appearance of a finished award trophy;
presenting the incomplete award trophy assembly to a recipient of an award from an organization;
preparing a flexible elongated placard strip having a length substantially equivalent to the external circumference of the cylindrical side wall, making at least two connector holes through the placard strip at a location spaced substantially close to the ends of the placard strip and positioning the connector holes such that they exactly overlay the connector holes when the placard is assembled to the side wall of the base, and adding indicia pertinent to the award that has been presented to the recipient;
providing the indicia-containing placard strip to the recipient, and providing connecting members sized and shaped to pass through the connector holes of the placard strip and fit securely in the closely spaced holes of the side wall;
subsequently wrapping the indicia-containing placard strip onto the side wall of the previously presented incomplete award trophy and aligning the connector holes of the placard strip with the closely spaced holes of the incomplete award trophy, and using the connecting members to secure the indicia-containing placard strip to the side wall to thereby prepare a completed award trophy with award indicia secured thereto.

20. The method of claim 19, wherein said wrapping and securing of the indicia-containing placard strip to the side wall includes exhibiting an appearance of the completed award trophy that is substantially the same as that of the incomplete award trophy.
